(19) United States
(12) Patent Application Publication
(10) Pub. No.: US 2025/0225510 A1
(43) Pub. Date: Jul. 10, 2025

(54) VIRTUALIZED HARDWARE SECURITY MODULE

(71) Applicant: Marvell Asia Pte Ltd, Singapore (SG)

(72) Inventors: Deepanshu Tyagi, Hapur (IN); Phanikumar Kancharla, Fremont, CA (US); Dhanalakshmi Saravanan, Bangalore (IN); Bapu Hinge, Bangalore (IN); Prateek Johri, Bareilly (IN); Raga Sruthi Nemalipuri, Hyderabad (IN); Rajendar Kalwa, Hyderabad (IN)

(21) Appl. No.: 18/762,385

(22) Filed: Jul. 2, 2024

Related U.S. Application Data
(60) Provisional application No. 63/617,517, filed on Jan. 4, 2024.

(51) Int. Cl. G06Q 20/38; G06Q 20/40

(52) U.S. Cl. CPC G06Q 20/3823; G06Q 20/3827; G06Q 20/3829; G06Q 20/4012; G06Q 20/4018

(57) ABSTRACT

A hardware security module (HSM) includes a first HSM instance and a second HSM instance. The first HSM instance is configured to process a first type of service request. The second HSM instance is configured to process a second type of service request. The first HSM instance and the second HSM instance are physically on a same HSM. The first HSM instance is logically separated from the second HSM instance. The first type of service request is a service request that differs from the second type of service request.

### RELATED APPLICATIONS

The instant application is a nonprovisional patent application that claims the benefit and priority to the provisional patent application No. 63/617,517 that was filed on Jan. 4, 2024, which is incorporated herein by reference in its entirety.

### BACKGROUND

A hardware security module (HSM) is a physical computing device that safeguards and manages secret and confidential information (e.g., digital keys and data) of a user which applications use the HSM. A HSM typically has certain security protection measures in place to prevent tampering by cyberattacks and play a vital role in providing a security environment for various cryptographic operations such as encryption and decryption, digital signatures, strong authentication, as well as other cryptographic functions. HSMs are mainly used to generate, derive, store, and manage cryptographic keys, secure computation via encryption and decryption, and protect sensitive data of the user from unauthorized access and attacks.

Keys for general-purposed applications (or general applications), e.g., encryption/decryption, digital signatures, authentication, etc., are typically different from keys for special-purposed applications (or special applications), e.g., key used for payment application. As such, different HSMs may need to be used for general application and special applications, respectively. The need to utilize different HSMs for different kinds of applications is not only costly, but it also leads to inefficient use of the HSMs.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a system including a virtualized hardware security module (HSM) according to one aspect of the present embodiments.

FIG. 2 depicts an example of a diagram of an instance of a HSM according to one aspect of the present embodiments.

FIG. 3 depicts another example of a system including a virtualized HSM according to one aspect of the present embodiments.

FIG. 4 depicts yet another example of a system including a virtualized HSM according to one aspect of the present embodiments.

FIG. 5 depicts another example of a system including another virtualized HSM according to one aspect of the present embodiments.

FIG. 6 depicts a flowchart of an example of a process to process a request by a HSM according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

A need has arisen to use a single physical HSM that is virtualized so that each virtualized HSM (also referred to as an HSM instance) running on the single HSM can service an application with a different set of keys. In other words, a HSM is logically (but not physically) partitioned such that each partition of the HSM is capable of servicing one or more types of service requests (general versus special). As such, special keys used for a special application, which can be but is not limited to a payment application may be serviced by one instance of the HSM while general keys (e.g., encryption/decryption, etc.) used for other cryptographical operations may be services by another instance of the HSM. Virtualization of the HSM reduces the cost because the need to have one HSM to service special applications while another HSM to service general applications is eliminated. It is appreciated that throughout this application, the examples are described with respect to a single HSM with two instances (two virtualized partitions) for illustration purposes but should not be construed as limiting the scope of the embodiments. For example, an HSM may be virtualized to include three or more instances capable of servicing three or more types of service requests.

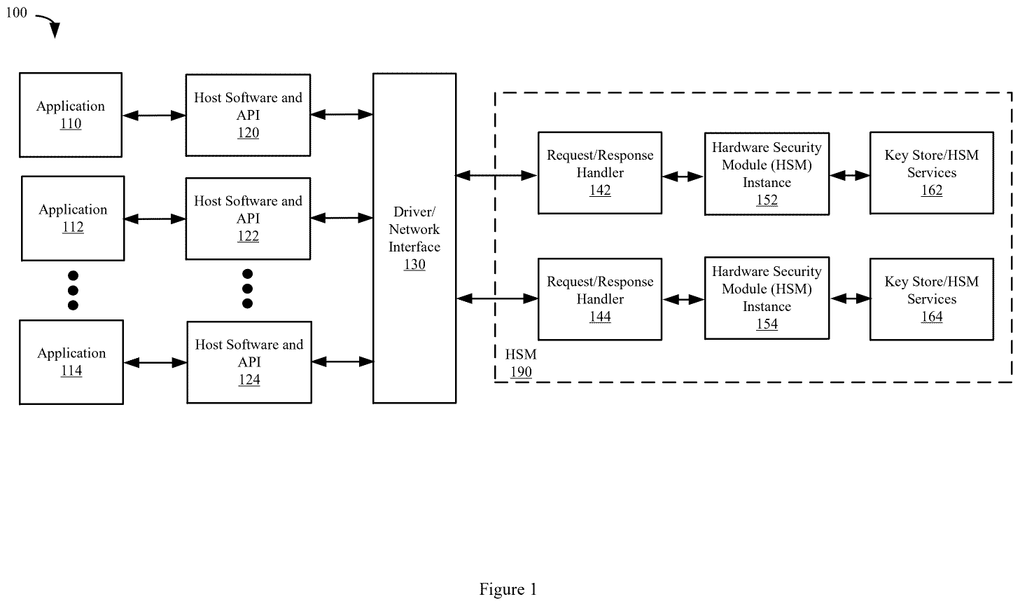

FIG. 1 depicts an example of a diagram of a system including a virtualized HSM according to one aspect of the present embodiments. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a virtualized HSM 190. The system 100 includes one or more applications 110-114 that generate one or more service requests, e.g., cryptographical operations, for the HSM 190. In one nonlimiting example, the cryptographical operations may include one or more of key management, encryption/decryption, digital signature and verification, authentication, auditing, secure code execution, etc. According to some embodiments, the cryptographical operations may be either a general type or a special type. General cryptographical operations may include operations where the keys used for those operations are general purpose keys whereas special cryptographical operations such as payment applications (e.g., credit card transaction, payment transactions, etc.) may include operations where the keys are special purpose keys. It is appreciated that general cryptographical operations may include encryption, decryption, sign and verify, key generation, hashing operation, key wrapping, etc. Special cryptographical operations may be related to payment processing and may include one or more of pin translation, Europay Mastercard Visa (EMV) operation, card verification value (CVV) generation and verification, derive unique key per transaction (DUKPT), etc. DUKPT is used as an example of key management scheme used by point of sale (PoS) device to derive unique key per transaction, e.g., when a card is swiped, e.g., at an automatic teller machine (ATM).

In one nonlimiting example, the applications 110-114 may be running on a single host or different hosts. In one nonlimiting example, the application 110 may be a payment application running on a hardware, e.g., smartphone, laptop, etc. In one nonlimiting example, the application 110 can be but is not limited to a cloud-based user application, e.g., one hosted by a web service such as Amazon Web Service (AWS).

According to one nonlimiting example, each application may be associated with its own host software and application programming interface (API), as illustrated. For example, application 110 may be associated with the host software and API 120, while application 112 may be associated with the host software and API 122, and application 114 may be associated with the host software and API 124. In one nonlimiting example, two or more applications may be serviced by a common host software and API (not shown). For example, a first host software and API may be used for general purpose cryptographical operations that service two or more applications while a second host software and API may be used for special cryptographical operations associated with payment processing, as an example.

In some embodiments, the driver/network interface 130 may receive the service request and/or data to perform one or more cryptographical operations from the applications 110-114 via the host software and APIs 120-124. In one nonlimiting example, the application 110 may communicate with the HSM 190 via the driver/network interface 130, e.g., over a network following certain communication protocols such as TCP/IP protocol. Such a network can be but is not limited to, internet, intranet, wide area network (WAN), local area network (LAN), wireless network, Bluetooth, WiFi, mobile communication network, or any other network type. In one nonlimiting example, the application 110 may communicate with HSM 190 via a driver of the driver interface.

In some embodiments, the HSM 190 is a single physical HSM that has been virtualized and includes multiple instances to service cryptographical operations associated with general service requests and special service requests, e.g., payment processing. In one nonlimiting example the HSM 190 may include a multi-chip embedded hardware/firmware cryptographic module having software, firmware, hardware, or another component that is used to effectuate a purpose. In some embodiments, the one or more processors include a multi-core processor and a security processor, wherein the security processor is configured to perform crypto operations with hardware accelerators with embedded software implementing security algorithms. In some embodiments, the HSM 190 is certified under Federal Information Processing Standard (FIPS) Level 2 and 3 for performing secured key management cryptographic (crypto) operations. In some embodiments, the HSM 190 is preconfigured with default network and authentication credentials so that the HSM 190 can be FIPS/Common Criteria/PCI compliant for key management and crypto operations. In some embodiments, the FIPS certified HSM 190 includes one or more processors and storage units (not shown). In one nonlimiting example, the cryptographical operations may include one or more of key management, encryption/decryption, digital signature and verification, authentication, auditing, secure code execution, etc. HSM 190 is designed to perform cryptographical operations efficiently.

In one nonlimiting example, the HSM 190 has been partitioned to logically create two or more instances of the HSM where one instance is configured to service requests associated with general cryptographical operations whereas another instance is configured to service requests associated with special cryptographical operations, e.g., payment related operations. It is appreciated that general service requests may use general purpose keys whereas special service requests may use special purpose keys.

In one nonlimiting example, the HSM 190 is configured to include a first instance and a second instance. The first and the second instance are logically separate but physically within the same HSM 190. The first instance includes a request/response handler 142, an HSM instance 152, and a key store/HSM services 162. The second instance includes a request/response handler 144 an HSM instance 154, and a key store/HSM services 164. In one nonlimiting example, the first instance may be associated with special cryptographical operations and the second instance may be associated with general cryptographical operations. It is appreciated that in one nonlimiting example, the second instance only processes service requests associated with general cryptographical operations (not special cryptographical operations) and the first instance only processes service requests associated with special cryptographical operations (not general cryptographical operations).

In some embodiments, the request/response handler of each HSM instance is configured to process the received service request. For example, the service request may include an identifier, e.g., class, flag, etc., to determine whether it is a request for general cryptographical operations or a special cryptographical operations. In one nonlimiting example, a set flag may indicate that the service request is a special cryptographical operation class whereas if the flag is not set may indicate that the service request is a general cryptographical operation class. The request/response handler may use the identifier to determine whether the service request is a special cryptographical operation or a general cryptographical operation. In this example, both the request/response handlers 142 and 144 process the service request. If the service request is determined to be special cryptographical operation, e.g., payment related, then the request/response handler 144 drops it since the second instance is associated with general cryptographical operations. In contrast, the request/response handler 142 determines that the service request is a special cryptographical operation and processes it.

In one nonlimiting example, the request/response handler 142 processes the service request that may include an opcode. The opcode identifies the operation to be performed. For example, the opcode may indicate that authentication is to be performed for a special cryptographical operation in the first HSM instance. It is also appreciated that the service request may include data associated with the opcode. For example, if the opcode indicates that authentication is requested, then the data portion of the service request may include the credit card number, the code verification value, etc. The request/response handler 142 relays the service request (e.g., special cryptographical operation) to the HSM instance 152 for processing. The HSM instance 152 may access its respective key store/HSM service 162 to fetch the appropriate key, e.g., special key if the service request is for a special cryptographical operation, and further perform the appropriate operation, e.g., encryption. The HSM instance 152 may transmit the processed service request back to the request/response handler 142 for transmission back to the requesting application, e.g., application 110. It is appreciated that a general cryptographical operation may be processed similar to that of special cryptographical operation except by the second instance (e.g., request/response handler 144, the HSM instance 154, and key store/HSM services 164).

Accordingly, the service request received by the HSM 190 may be executed in the first instance (special purpose domain) or the second instance (general purpose domain) of the HSM 190. Therefore, the need to have two physically HSMs one for general purpose cryptographical operations and one for special purpose cryptographical operations is eliminated.

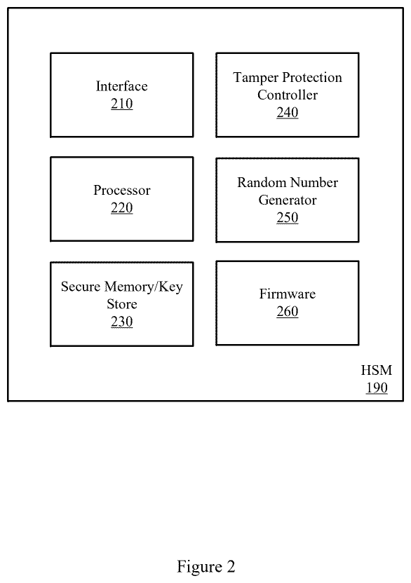

FIG. 2 depicts an example of a diagram of an instance of the HSM 190 according to one aspect of the present embodiments. In one nonlimiting example, the HSM 190 may include multiple modules including interface 210, processor 220, secure memory/key store 230, tamper protection controller 240, random number generator 250, and a firmware 260.

According to one example, the interface 210 may receive the requests, e.g., request and/or data associated with one or more cryptographic operations, e.g., encryption, decryption, sign and verify, key generation, hashing operation, key wrapping, or one or more of pin translation, EMV operation, CVV generation and verification, DUKPT, etc. The interface 210 may be configured to parse each of the plurality of service requests and to identify a type of service requested, e.g., special versus general, by a specific application. Various types of service requests may be any cryptographic operations including but are not limited to key management (e.g., key generation, key export, key deletion, secured key and data storage), crypto (e.g., encryption and decryption) operations of the keys and data, digital signature and verification (e.g., generate digital signature and verification), authentication (to ensure that only authorized users and systems can access certain data, auditing (for forensic analysis and compliance), secure code execution (to execute custom code in secure boundaries), pin translation, EMV operation, CVV generation and verification, DUKPT, etc. The interface 210 may invoke the corresponding handler/component of the key management and crypto operation module to process the specific type of service requested by the application together with the data embedded in or pointed to by the service request. Once the service request has been processed by the key management and crypto operation module, the interface 210 may compose a response including a processing result and transmit the response back to the application sending the service request.

In one nonlimiting example, the processor 220 may be used to perform one or more types of service request. For example, the processor 220 may be configured to perform a key management (by using the secure memory/key store 230) or crypto operation/service (e.g., advanced encryption standard (AES) operation, data encryption standard (DES) operation, etc.) according to the type of service requested, e.g., general or special. For non-limiting examples, the key management or crypto operation can be but is not limited to, generating a new key, storing the key into the key store 230, exporting the key back to the application 110, deleting an existing key from the key store 230, encrypting or decrypting data using the key, and storing the encrypted or decrypted data in the key store 230. The key store 230 may be a secure memory component used for key management. The processor 220 may use the secure memory/key store 230 for key management and crypto operation and further to provide the processing result (e.g., the generated key) back to the requesting application 110 through the interface 210. In some embodiments, the key management and crypto operation may be configured to stop or abort the key management or crypto operation if an alert of potential security compromise is raised for the specific operation and/or the application requesting the service.

In one nonlimiting example, the secure memory/key store 230 is configured to maintain various types of information/data associated with the plurality of applications in a secure environment. Such information includes but is not limited to keys, encrypted data, decrypted data and any other confidential or proprietary information of each of the plurality of applications. In some embodiments, the secure memory/key store 230 includes multiple types of storage devices, including but not limited to, dynamic random access memory (DRAM) and flash for key and data storage, ferroelectric RAM (FRAM) for storing critical logs, and eFuse for one time key write that cannot be erased, etc.

According to one nonlimiting example, the tamper protection controller 240 may be used to ensure that the data and/or request is not tampered with and if the tamper protection controller 240 detects tampering, then the request and/or operation may be aborted. In one nonlimiting example, the random number generator 250 may be used to generate a random number that may be used for encryption/decryption. The HSM 190 may be implemented as part of the firmware 260, in one nonlimiting example.

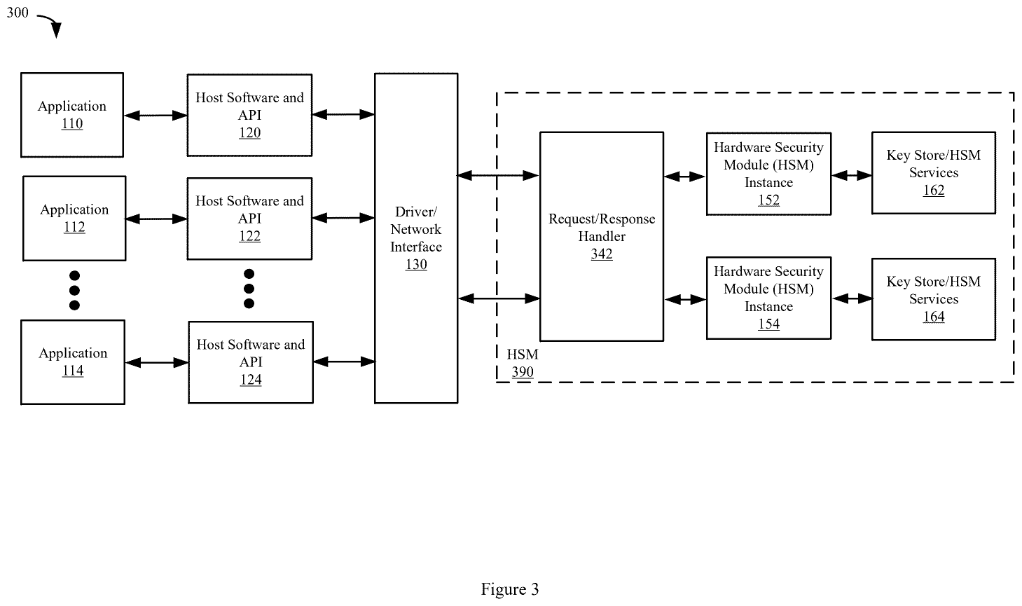

FIG. 3 depicts another example of a system 300 including a virtualized HSM 390 according to one aspect of the present embodiments. HSM 390 is similar to that of HSM 190 except that one request/response handler 342 is used for both general and special service requests. In one nonlimiting example, the request/response handler 342 is configured to parse the service request that is received and based on the identifier of the service request it may determine whether the service request to be sent to HSM instance 152 and its corresponding key store/HSM services 162, or to HSM instance 154 and its corresponding key store/HSM service 164.

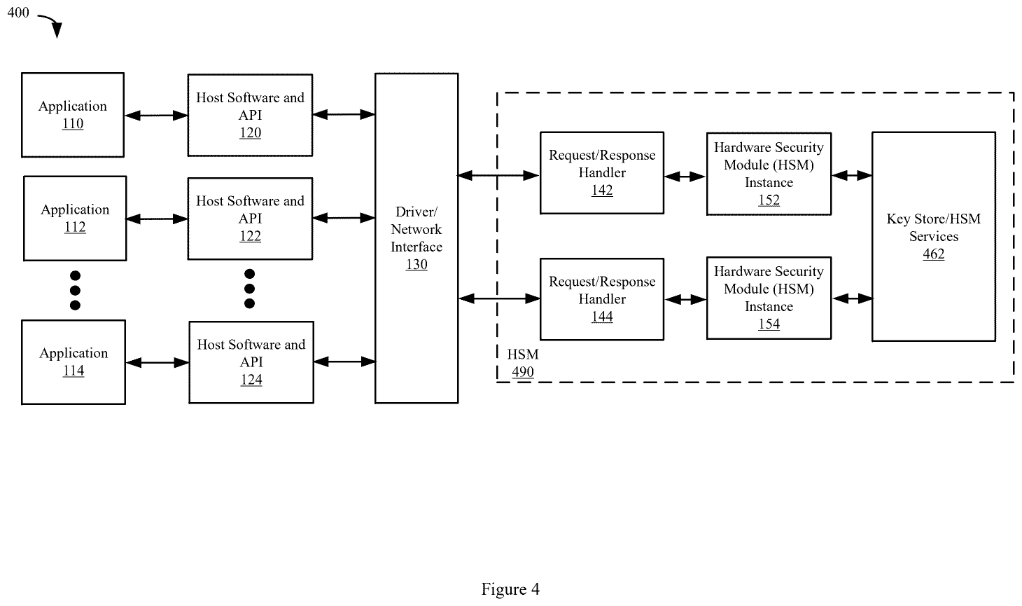

FIG. 4 depicts yet another example of a system 400 including a virtualized HSM 490 according to one aspect of the present embodiments. HSM 490 is similar to that of HSM 190 except that one key store/HSM services 462 is used for both general and special service requests. In one nonlimiting example, the service request, if special, is sent to the HSM instance 152 which accesses the key store/HSM services 462 to process and if general, is sent to the HSM instance 154 which accesses the key store/HSM services 462 to process.

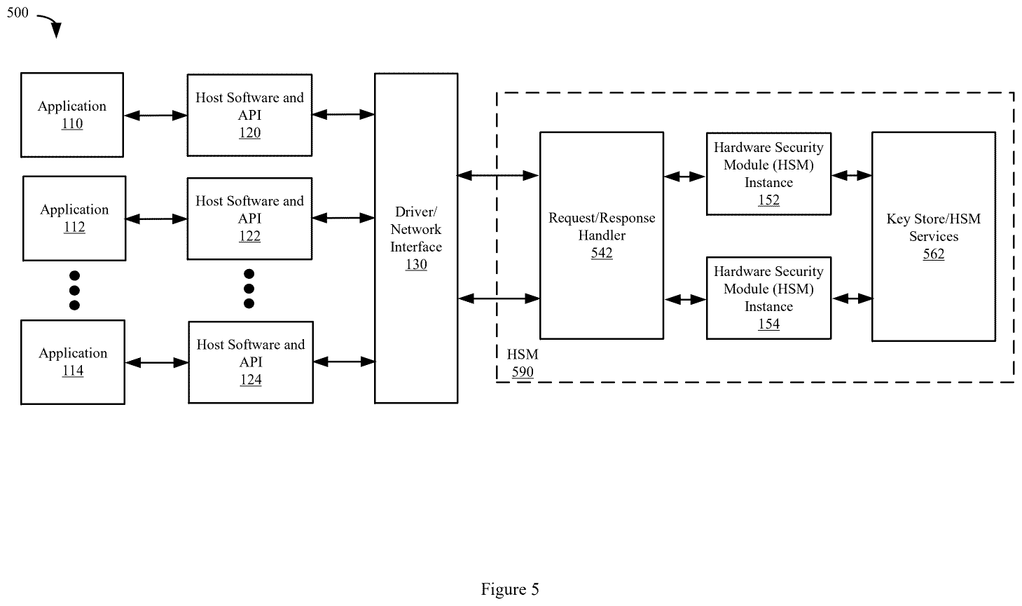

FIG. 5 depicts another example of a system 500 including another virtualized HSM 590 according to one aspect of the present embodiments. HSM 590 is similar to that of HSM 190 except that one request/response handler 542 and one key store/HSM services 562 is used for both general and special service requests (for both HSM instances 152 and 154).

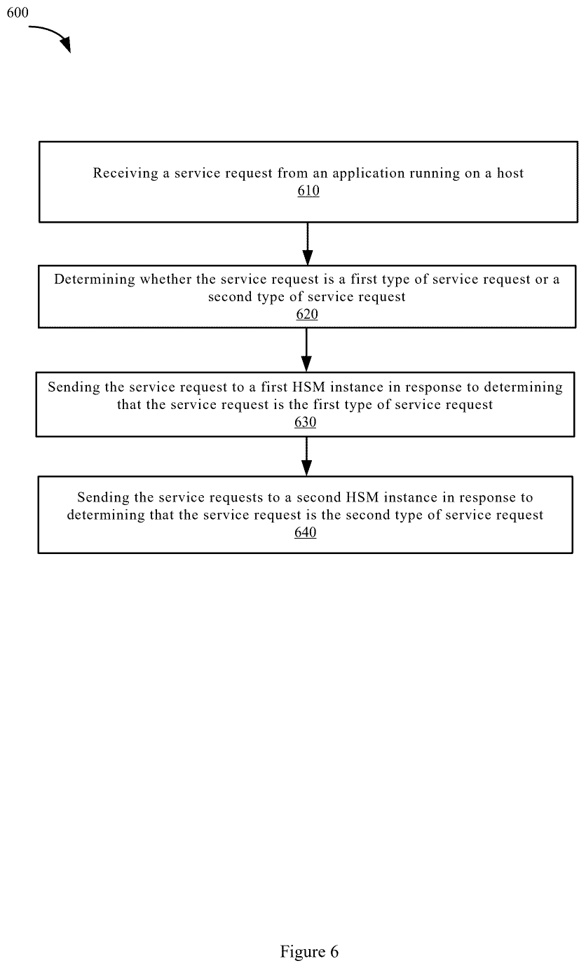

FIG. 6 depicts a flowchart of an example of a process to process a request by a HSM according to one aspect of the present embodiments. At step 610, a service request is received from an application running on a host, as described above in FIGS. 1-5. At step 620, it is determined whether the service request is a first type of service request (special) or a second type of service request (e.g., general), as described above. At step 630, the service request is sent to a first HSM instance in response to determining that the service request is the first type of service request, as described above in FIGS. 1-5. At step 640, the service request is sent to a second HSM instance in response to determining that the service request is the second type of service request, as described above in FIGS. 1-5. It is appreciated that the first HSM instance and the second HSM instance are physically on a same HSM but are logically separated from one another.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A hardware security module (HSM) comprising:
a first HSM instance configured to process a first type of service request; and
a second HSM instance configured to process a second type of service request;
wherein the first HSM instance and the second HSM instance are physically on a same HSM, and wherein the first HSM instance is logically separated from the second HSM instance,
wherein the first type of service request is a service request that differs from the second type of service request.

2. The HSM of claim 1, wherein the first HSM instance is configured to only process the first type of service request.

3. The HSM of claim 1, wherein the second HSM instance is configured to only process the second type of service request.

4. The HSM of claim 1, wherein the first type of service is at least one or more of encryption, decryption, sign and verify, key generation, hashing, key wrapping, auditing, authentication, and tamper protection.

5. The HSM of claim 1, wherein the second type of service is a cryptographical operation associated with payment.

6. The HSM of claim 5, wherein the cryptographical operation is at least one or more of pin translation, euro master visa (EMV) operation, a code verification value (CVV) generation and verification, and a derive unique key per transaction (DUKPT) operation.

7. The HSM of claim 1 further comprising a first partition associated with the first HSM instance and a second partition associated with the second HSM instance.

8. The HSM of claim 1 further comprising a handler configured to process a request received from an application and a response to be sent to the application.

9. The HSM of claim 1 further comprising a first handler associated with the first HSM instance and a second handler associated with the second HSM instance, wherein each handler is configured to process a request received from an application and a response to be sent to the application, and wherein the first handler is physically separate from the second handler.

10. The HSM of claim 1 further comprising a key store/HSM service module configured for key management and cryptographical operations.

11. The HSM of claim 1 further comprising a first key store/HSM service module associated with the first HSM instance and a second key store/HSM service module associated with the second HSM instance, wherein each key store/HSM service module is configured for key management and cryptographical operations, and wherein the first key store/HSM service module is physically separate from the second key store/HSM service module.

12. A method comprising:
receiving a service request from an application running on a host;
determining whether the service request is a first type of service request or a second type of service request;
sending the service request to a first hardware security module (HSM) instance in response to determining that the service request is the first type of service request; and
sending the service request to a second HSM instance in response to determining that the service request is the second type of service request, wherein the first HSM instance and the second HSM instance are physically on a same HSM, and wherein the first HSM instance is logically separated from the second HSM instance.

13. The method of claim 12, wherein the first HSM instance is configured to only process the first type of service request.

14. The method of claim 12, wherein the second HSM instance is configured to only process the second type of service request.

15. The method of claim 12, wherein the first type of service is at least one or more of encryption, decryption, sign and verify, key generation, hashing, key wrapping, auditing, authentication, and tamper protection.

16. The method of claim 12, wherein the second type of service is a cryptographical operation associated with payment.

17. The method of claim 16, wherein the cryptographical operation is at least one or more of pin translation, euro master visa (EMV) operation, a code verification value (CVV) generation and verification, and a derive unique key per transaction (DUKPT) operation.

18. The method of claim 12, wherein the HSM includes a first partition associated with the first HSM instance and a second partition associated with the second HSM instance.

19. The method of claim 12 further comprising parsing the received service request to determine a type of service request based on a class portion of the received service request.

20. The method of claim 12 further comprising parsing the received service request to determine a type of service requests based on an opcode of the received service request, wherein the opcode identifies cryptographical operation to be performed.

21. The method of claim 12 further comprising performing key management and cryptographical operations associated with the service request.

22. A system comprising:
a means for receiving a service request from an application running on a host;
a means for determining whether the service request is a first type of service request or a second type of service request;
a means for sending the service request to a first hardware security module (HSM) instance in response to determining that the service request is the first type of service request; and
a means for sending the service requests to a second HSM instance in response to determining that the service request is the second type of service request,
wherein the first HSM instance and the second HSM instance are physically on a same HSM, and wherein the first HSM instance is logically separated from the second HSM instance.
